(19) United States
(12) Patent Application Publication
(10) Pub. No.: US 2008/0074031 A1
(43) Pub. Date: Mar. 27, 2008

(54) Field emission display and method for manufacturing same

(75) Inventor: Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/903,772

(22) Filed: Sep. 24, 2007

(30) Foreign Application Priority Data
Sep. 22, 2006 (TW) 95135197

(51) Int. Cl. H01J 63/04; H01J 9/00

(52) U.S. Cl. 313/496; 445/24

(57) ABSTRACT

An exemplary field emission display includes a first substrate (21) and a second substrate (22) being at opposite sides of the field emission display, a metal layer (210) disposed on an inner surface of the first substrate, a transparent electrode (221) disposed on an inner surface of the second substrate and spaced apart from the metal layer, a fluorescent layer (223) disposed on the transparent electrode, and a poly-silicon layer (212) disposed on the metal layer. The poly-silicon layer defines a plurality of tips (218) pointing toward the fluorescent layer. A method for manufacturing a field emission display is also provided.

### FIELD OF THE INVENTION

The present invention relates to flat panel displays, and more particularly to a field emission display (FED) and a method for manufacturing the FED.

### BACKGROUND

In recent years, flat panel display devices have been developed and widely used in electronic applications such as personal computers. One popular kind of flat panel display device is an active matrix liquid crystal display (LCD) that provides high resolution. However, typical LCDs have many inherent limitations that render them unsuitable for a number of applications. For instance, LCDs have numerous manufacturing shortcomings. These include a slow deposition process inherent in coating a glass panel with amorphous silicon, high manufacturing complexity, and low yield of units having satisfactory quality. In addition, LCDs generally require a fluorescent backlight. The backlight draws high power, yet most of the light generated is not viewed and simply wasted. Furthermore, an LCD image is difficult to see under bright light conditions and at wide viewing angles. Moreover, since the response time of an LCD is dependent upon the response time of liquid crystal to an applied electrical field, the response time of the LCD is correspondingly slow. A typical response time of an LCD is in the range from 5 milliseconds (ms) to 75 ms. Such difficulties limit the use of LCDs in many applications such as High-Definition TVs (HDTVs) and large displays. Plasma display panel (PDP) technology is more suitable for HDTVs and large displays. However, a PDP consumes a lot of electrical power. Further, the PDP device itself generates too much heat.

Other flat panel display devices have been developed in recent years to improve upon LCDs and PDPs. One such flat panel display device, an FED device, overcomes some of the limitations and provides significant advantages over conventional LCDs and PDPs. For example, typical FED devices have higher contrast ratios, wider viewing angles, higher maximum brightness, lower power consumption, shorter response times, and broader operating temperature ranges when compared to conventional thin film transistor liquid crystal displays (TFT-LCDs) and PDPs.

One of the most important differences between an FED and an LCD is the way that light for generating an image is produced. Unlike the LCD, the FED produces its own light utilizing colored phosphors. The FED does not require complicated, power-consuming backlights and associated filters. Almost all light generated by an FED is viewed by a user. Furthermore, the FED does not require large arrays of thin film transistors. Thus, the problems of a costly light source and low yield associated with active matrix LCDs are eliminated.

In an FED device, electrons are extracted from tips of a cathode by applying a voltage to the tips. The electrons impinge on phosphors on the back of a transparent cover plate and thereby produce an image. The emission current, and thus the display brightness, is highly dependent on the work function of an emitting material at the field emission source of the cathode. To achieve high efficiency for an FED device, a suitable emitting material must be employed.

FIG. 5 shows a schematic, cross-sectional view of a pixel region of a typical FED. The FED 10 includes a first substrate 11, a second substrate 12, a metal layer 110, an insulating layer 112, a gate electrode 114, a plurality of tips 116, a transparent electrode 121, and a fluorescent layer 123.

The first and second substrates 11 and 12 are disposed parallel to and spaced apart from each other. The metal layer 110 is disposed on an inner surface of the first substrate 11, and the insulating layer 112 is disposed on the metal layer 110. The gate electrode 114 is disposed on the insulating layer 112, and the gate electrode 114 and the insulating layer 112 cooperatively define a plurality of openings 118 thereat. The tips 116 are vertically disposed in the openings 118 respectively. The transparent electrode 121 is disposed on an inner surface of the second substrate 12, and the fluorescent layer 123 is coated on the transparent electrode 121. The metal layer 110 functions as a cathode, the transparent electrode 121 functions as an anode, and the tips 116 function as electron-emitting sources.

The tips 116 of the FED 10 are made of metallic material. The process of manufacturing the tips 116 is complicated. Referring to FIGS. 6-11, these are schematic, sectional views of one pixel region, showing sequential stages in a process of manufacturing the FED 10.

FIGS. 6-7 shows the initial stage of providing a first substrate 11, and applying a metal layer 210 on the first substrate 11. Then, an insulating layer 112 is provided on the metal layer 110. The insulating layer 112 may be made of silicon oxide.

In the next step illustrated in FIG. 8, a gate electrode 114 is coated on the insulating layer 112. The gate electrode 114 is made of Cb (columbium). Then a plurality of openings 118 is formed in the gate electrode 114 and the insulating layer 112 in common, by an etching process.

In the next step illustrated in FIG. 9, an aluminum layer 113 is coated on the gate electrode 114 via a side deposition process. The aluminum layer 113 does not fill or cover the openings 118. The aluminum layer 113 is used as a sacrificial layer, which is peeled off in subsequent processing.

FIG. 10 illustrates the step of forming the tips 116. A Cr (chromium) layer 115, a Cb layer 117, and a Mo (molybdenum) layer 119 are coated on the aluminum layer 113 and also filled in the openings 118, in that order from bottom to top. Thereby, a tip 116 is formed in each of the openings 118.

In the final step illustrated in FIG. 11, the aluminum layer 113 and the metal layers 115, 117 and 119 thereon are peeled off. Thereby, the process of manufacturing structures on the first substrate 11 is finished. The first substrate 11 with the structures thereon is a cathode substrate. After that, the transparent electrode 121 and the fluorescent layer 123 are disposed on the second substrate 12, with the resulting combination being an anode substrate. Finally, the cathode substrate and the anode substrate are attached together to form a hermetically sealed assembly, with the cathode and anode substrates spaced apart and separated by a vacuum. Thereby, the field emission display 10 is obtained.

However, the field emission display 10 employs a great deal of expensive metallic materials, such as Cb, Cr, and Mo. Substantial portions of these metallic materials are removed during the manufacturing process. Thus the manufacturing process is inherently wasteful and costly. Moreover, the manufacturing process needs five or six mask processes. Thus the manufacturing process is complicated and expensive.

Accordingly, what is needed is an FED and a method for manufacturing the FED that can overcome the above-described deficiencies.

### SUMMARY

An FED includes a first substrate and a second substrate being at opposite sides of the field emission display, a metal layer disposed on an inner surface of the first substrate, a transparent electrode disposed on an inner surface of the second substrate and spaced apart from the metal layer, a fluorescent layer disposed on the transparent electrode, and a poly-silicon layer disposed on the metal layer. The poly-silicon layer defines a plurality of tips pointing toward the fluorescent layer.

A method for manufacturing an FED includes: providing a first substrate; forming a metal layer on the first substrate; forming an amorphous silicon layer on the metal layer; treating the amorphous silicon layer to form a poly-silicon layer with a plurality of tips; providing a second substrate; forming an electrode on the second substrate; forming a fluorescent layer on the transparent electrode; and attaching the first and second substrates together such that the tips point toward and are spaced apart from the fluorescent layer.

Other novel features and advantages will become apparent from the following detailed description of preferred and exemplary embodiments when taken in conjunction with the accompanying drawings. In the drawings, all the views are schematic.

### BRIEF DESCRIPTION OF THE DRAWINGS

FIG. 1 is a cross-sectional view of part of an FED according to an exemplary embodiment of the present invention.

FIGS. 2-4 are sectional views showing sequential stages of an exemplary method for manufacturing the FED of FIG. 1.

FIG. 5 is a cross-sectional view of a pixel region of a conventional FED.

FIGS. 6-11 are sectional views of one pixel region, showing sequential stages in a process of manufacturing the FED of FIG. 5.

### DETAILED DESCRIPTION OF PREFERRED EMBODIMENTS

Reference will now be made to the drawings to describe preferred and exemplary embodiments in detail.

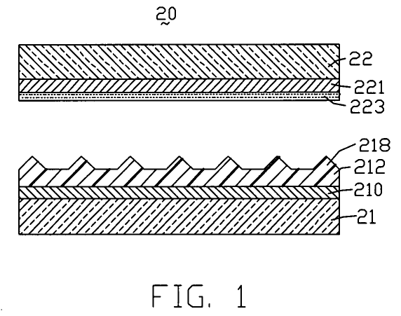

Referring to FIG. 1, this is a schematic, cross-sectional view of an FED according to an exemplary embodiment of the present invention. The FED 20 includes a first substrate 21, a second substrate 22, a metal layer 210, a transparent electrode 221, a fluorescent layer 223, and a poly-silicon layer 212 having a plurality of tips 218.

The first substrate 21 may be transparent or opaque, and the second substrate 22 is transparent. The first and second substrates 21 and 22 are disposed parallel to and spaced apart from each other. The metal layer 210 is disposed on an inner surface of the first substrate 21, and is made of aluminum. The metal layer 210 functions as a cathode. The poly-silicon layer 212 is disposed on the metal layer 210. The poly-silicon layer 212 with the tips 218 is formed by an excimer laser micromachining process. In such process, an amorphous silicon layer is converted into the poly-silicon layer 212 via a crystallization process. The tips 218 are spaced apart at regular intervals, and point toward the fluorescent layer 223. The tips 218 are used as electron-emitting sources.

The transparent electrode 221 is disposed on an inner surface of the second substrate 22, and is made of indium tin oxide or indium zinc oxide. The electrode layer 221 functions as an anode. The fluorescent layer 223 is disposed on the transparent electrode 221. The fluorescent layer 223 includes red fluorescent material selected from Y₂O₃:Eu and Y₂O₂S:Eu, green fluorescent material selected from SrGa₂S₄:Eu, Y₂SiO₅:Tb, and ZnS:(Cu, Al), and blue fluorescent material selected from Y₂SiO₅:Ce and ZnS:Ag.

After assembly, a region between the first and second substrates 21, 22 is in a vacuum state, and a distance between the metal layer 210 and the transparent electrode 221 is in the range from 0.2 mm to 1.0 mm. In operation, a voltage is applied to the cathode metal layer 210 and the anode transparent electrode 221, so as to enable the tips 218 to emit electrons. Then the electrons impinge the fluorescent powder of the fluorescent layer 223 to generate red, green, and/or blue light beams, for displaying of images.

As detailed above, the tips 218 of the poly-silicon layer 212 are used as the electrons-emitting sources of the FED 20, and the tips 218 are formed by an excimer laser micromachining process. In this micromachining process, there is no metallic material needed. In particular, unlike with a conventional FED, there is no wastage of valuable metals such as Cr, Cb, and Mo. Therefore the FED 20 can be obtained at a substantially reduced cost.

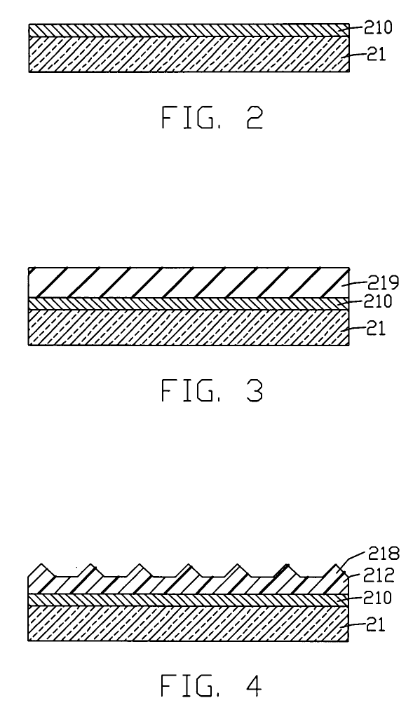

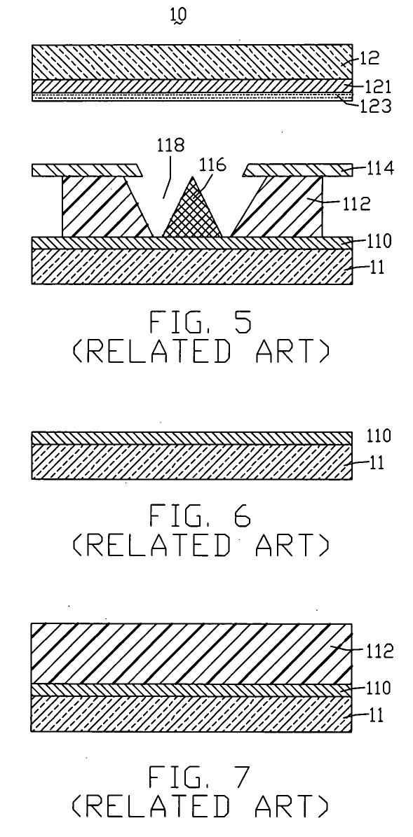

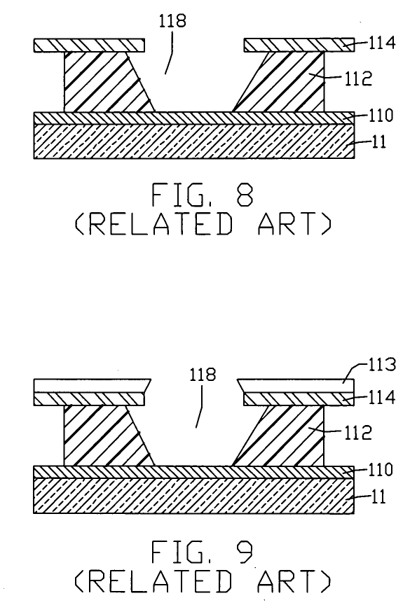

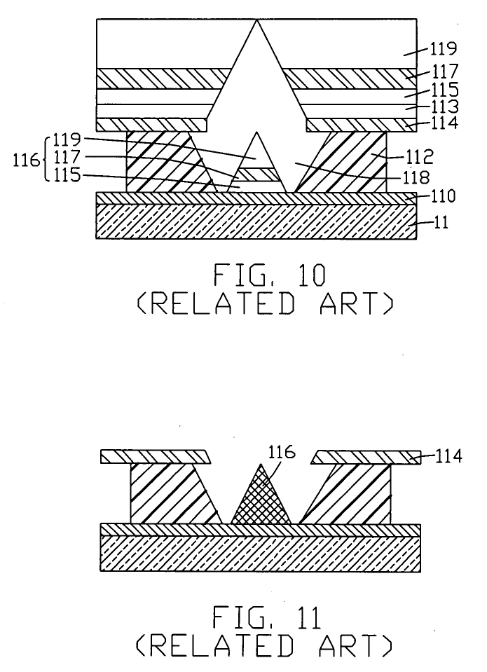

Referring to FIGS. 2-4, these are schematic, sectional views showing sequential stages of an exemplary method for manufacturing the FED 20. The method includes the following steps:

FIG. 2 shows the initial stage of providing a first substrate 21, which may be transparent or opaque. A metal layer 210 is applied on the first substrate 21 via a physical vapor deposition process. A thickness of the metal layer 210 is in the range from 50 nanometers (nm) to 500 nm. Preferably, the metal layer 210 is made of aluminum.

In the next step illustrated in FIG. 3, an amorphous silicon layer 219 is applied on the metal layer 210 via a chemical vapor deposition process. During the chemical vapor deposition process, the gas source is SiH₄+H₂+PH₃, and the treating temperature is in the range from 100° C. to 500° C. The amorphous silicon layer 219 is a heavily doped amorphous silicon layer, with a thickness in the range from 30 nm to 200 nm.

FIG. 4 illustrates the step of forming a poly-silicon layer 212 with a plurality of tips 218. The amorphous silicon layer 219 is crystallized into the poly-silicon layer 212 via an excimer laser micromachining process. During the excimer laser micromachining process, a plurality of tips 218 is formed on a surface of the poly-silicon layer 212 simultaneously.

The metal layer 210 is used as a cathode. That is, by performing the above-described steps, a cathode substrate is obtained. An exemplary process for manufacturing an anode substrate is as follows:

A second substrate 22 is provided, which is a transparent substrate. A transparent electrode 221 is formed on a surface of the second substrate 22 via a physical vapor deposition process. A thickness of the transparent electrode 221 is in the range from 20 nm to 100 nm. The transparent electrode 221 is made of indium tin oxide or indium zinc oxide. After that, a fluorescent layer 223 is coated on the transparent electrode 221.

In the final step, the first and second substrates 21, 22 are attached together, with the tips 218 pointing toward the fluorescent layer 223. The first and second substrates 21, 22 are parallel to and spaced apart from each other a predetermined distance. A region between the first and second substrates 21, 22 is in a vacuum state. A distance between the metal layer 210 and the transparent electrode 221 is in the range from 0.2 mm to 1.0 mm.

Unlike with conventional FEDs, the tips 218 of the poly-silicon layer 212 are formed by crystallizing the amorphous silicon layer 219 using excimer laser micromachining technology. The process for manufacturing the FED 20 is simple and inexpensive.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A field emission display, comprising:
a first substrate;
a second substrate, the first and second substrates being at opposite sides of the field emission display;
a metal layer disposed on an inner surface of the first substrate;
a transparent electrode disposed on an inner surface of the second substrate, and spaced apart from the metal layer;
a fluorescent layer disposed on the transparent electrode; and
a poly-silicon layer disposed on the metal layer, the poly-silicon layer defining a plurality of tips pointing toward the fluorescent layer.

2. The field emission display as claimed in claim 1, wherein the poly-silicon layer with the tips thereof is formed by an excimer laser micromachining process.

3. The field emission display as claimed in claim 1, wherein a distance between the metal layer and the transparent electrode is in the range from approximately 0.2 mm to approximately 1.0 mm.

4. The field emission display as claimed in claim 1, wherein the metal layer is made of aluminum, and the transparent electrode is made of at least one of indium tin oxide and indium zinc oxide.

5. The field emission display as claimed in claim 1, wherein the fluorescent layer comprises red fluorescent material selected from Y₂O₃:Eu and Y₂O₂S:Eu, green fluorescent material selected from SrGa₂S₄:Eu, Y₂SiO₅:Tb, and ZnS:(Cu, Al), and blue fluorescent material selected from Y₂SiO₅:Ce and ZnS:Ag.

6. The field emission display as claimed in claim 1, wherein the second substrate is transparent.

7. A method for manufacturing a field emission display, comprising:
providing a first substrate;
forming a metal layer on the first substrate;
forming an amorphous silicon layer on the metal layer;
treating the amorphous silicon layer to form a poly-silicon layer with a plurality of tips;
providing a second substrate;
forming a transparent electrode on the second substrate;
forming a fluorescent layer on the transparent electrode; and
attaching the first and second substrates together such that the tips point toward and are spaced apart from the fluorescent layer.

8. The method as claimed in claim 7, wherein the poly-silicon layer with the plurality of tips is formed by an excimer laser micromachining process.

9. The method as claimed in claim 7, wherein the metal layer is applied on the first substrate via a physical vapor deposition process.

10. The method as claimed in claim 9, wherein the metal layer comprises aluminum, and has a thickness in the range from approximately 50 nm to approximately 500 nm.

11. The method as claimed in claim 7, wherein the amorphous silicon layer is applied on the metal layer via a chemical vapor deposition process.

12. The method as claimed in claim 11, wherein a gas source in the chemical vapor deposition process is SiH₄+H₂+PH₃.

13. The method as claimed in claim 12, wherein a temperature of the chemical vapor deposition process is in the range from approximately 100° C. to approximately 500° C.

14. The method as claimed in claim 11, wherein a thickness of the amorphous silicon layer is in the range from approximately 30 nm to approximately 200 nm.

15. The method as claimed in claim 7, wherein the transparent electrode is applied on the second substrate via a chemical vapor deposition process.

16. The method as claimed in claim 15, wherein the transparent electrode is made of indium tin oxide or indium zinc oxide, and a thickness of the transparent electrode is in the range from approximately 20 nm to approximately 100 nm.

17. The method as claimed in claim 7, wherein the fluorescent layer comprises red fluorescent material selected from Y₂O₃:Eu and Y₂O₂S:Eu, green fluorescent material selected from SrGa₂S₄:Eu, Y₂SiO₅:Tb, and ZnS:(Cu, Al), and blue fluorescent material selected from Y₂SiO₅:Ce and ZnS:Ag.

18. The method as claimed in claim 7, wherein a region between the first and second substrates is in a vacuum state after the first and second substrates are attached together, and a distance between the transparent electrode and the metal layer is in the range from approximately 0.2 mm to approximately 1.0 mm.

19. A field emission display comprising:
a first substrate;
a second substrate, the first and second substrates being at opposite sides of the field emission display;
a metal layer disposed on an inner surface of the first substrate;
a transparent electrode disposed on an inner surface of the second substrate, and spaced apart from the metal layer;
a fluorescent layer disposed on the transparent electrode; and
a poly-silicon layer disposed on the metal layer, the poly-silicon layer being uneven.
